(19) United States
(12) Patent Application Publication
(10) Pub. No.: US 2006/0013115 A1
(43) Pub. Date: Jan. 19, 2006

(54) Multi-stack optical information carrier

(75) Inventors: Christopher Busch, Eindhoven (NL); Marcello Leonardo Mario Balistreri, Eindhoven (NL); Emiel Peeters, Eindhoven (NL); Johannes Theodorus Adriaan Wilderbeek, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronic, N.V., Eindhoven (NL)

(21) Appl. No.: 10/526,181

(22) PCT Filed: Aug. 4, 2003
(86) PCT No.: PCT/IB03/03405

§ 371 Date: Mar. 1, 2005

(30) Foreign Application Priority Data
Sep. 6, 2002 (EP) 02078676.0

(51) Int. Cl. G11B 7/24

(52) U.S. Cl. 369/275.1; 369/272.1; 369/283

(57) ABSTRACT

The present invention relates to a multi-stack optical information carrier for recording information by means of an optical beam, said optical information carrier comprising—a substrate layer (S),—at least two recording stacks each comprising a recording layer (P1-P7),—at least one spacer layer (R) separating the at least two recording stacks, and—a cover layer (C). In order to improve the sensitivity during writing it is proposed according to the present invention that the recording layers (P1-P7) include a thermochromic material having temperature-dependent optical characteristics for selectively improving the sensitivity of the addressed recording layer (P1-P7) during recording and/or read-out.

The present invention relates to a multi-stack optical information carrier for recording information by means of an optical beam, said optical information carrier comprising
a substrate layer,
at least two recording stacks each comprising a recording layer,
at least one spacer layer separating the at least two recording stacks and
a cover layer.

Current multi-layer technologies, such as the two recording layer standard used for DVD, where two recording layers carrying the information are provided in two separated recording stacks, and the 10-20 recording layer fluorescent technology as, for instance, known from WO 98/50914 A1, address the layer for writing/reading by focusing a laser beam on it. Selectivity for writing is achieved by the laser intensity at the focal spot being much higher than in the non-addressed planes, thereby heating up only the desired spot above the threshold temperature. Read-out selectivity can be achieved by use of a (semi-) confocal set-up. In this way of addressing, the interaction of the light with the material is linear in intensity. Linear methods suffer from the fact that to reach the n^{th} layer, the light has to pass through the n-1 non-addressed layers, where interaction with the incident radiation is taking place. Further, integrated over the illuminated area the interaction is of the same order as the interaction in the addressed layer. This results in a trade-off between the loss of energy in these non-addressed layers and the sufficient interaction of the light in the addressed layer.

For read-out this results in a significant decrease in the signal intensity that is available for detection thus decreasing achievable data rates. The unwanted background from non-addressed layers can be eliminated by confocal detection.

For a system with constant layer properties the following expression for optimum read-out is obtained: Pᵢ∝R×(1−R)²ⁱ⁻² (in reflection).

To obtain maximum effective reflection of the deepest layer the interface reflection should be chosen as R=1/(2 N−1) with N the total number of layers.

In the case of fluorescence with the signal power Pᵢ∝α(1−η_{nf}α)ⁱ⁻¹ (a relative absorption, η_{nf} the overlap of the light beam with fluorescent area in the out-of-focus layers and to a good approximation equal to the filling ratio of 0.25), the optimal relative absorption is α=(η_{nf} N)⁻¹. The optimal interaction in linear multi-layer systems is thus inversely proportional to the number of layers.

For writing in a system with a significant number of layers, this poses a more severe restriction than for read-out, since to achieve the writing effect usually a much larger amount of energy has to deposited within the addressed layer. Therefore, the power requirements become prohibitively high and unwanted heating of non-addressed layers is adverse for material and media stability.

It is therefore an object of the present invention to provide a multi-stack optical information carrier in which one of many recording layers can be effectively addressed for writing/reading of data without much interaction with the non-addressed recording layers.

This object is achieved according to the present invention by a multi-stack optical information carrier as claimed in claim 1 which is characterized in that the recording layers include a thermochromic material having temperature-dependent optical characteristics for selectively improving the sensitivity of the addressed recording layer during recording and/or read-out.

The present invention is based on the idea to exploit the effect of thermochromic material to change the optical characteristics of the recording layers so that the optical characteristics of the recording layers show a temperature dependency. Thus, the sensitivity of the addressed recording layer can be increased above that of non-addressed recording layers. Preferably, the reflectivity or absorption of the recording layers is made temperature-dependent by use of a appropriate thermochromic material, as proposed according to preferred embodiments. In particular, the reflectivity or absorption, respectively, is increased at elevated temperatures.

According to the present invention the thermochromic material can at the same time be the recording material, but it is also possible that an additional recording material is present in the recording layers. Preferably the invention is applied in ROM or WORM (write once read many) optical disks such as CD-ROM, CD-R, DVD-ROM or BD (Blue ray disk).

In a preferred embodiment the recording layers comprise thermochromic material having a temperature-dependent reflection characteristic. In such an embodiment the mismatch of the refractive indices at elevated temperatures can be used for readout.

Preferably, the refractive index of the thermochromic material at ambient temperature is matched to the refractive index of said substrate and spacer layers.

In a preferred embodiment, the locally increased absorption and elevated temperature achieved with a thermochromic material are used to switch the temperature dependent reflection characteristic of a second material or reflection stack.

According to an advantageous embodiment two separate thermochromic materials having different degradation temperatures are used in the recording layers. Preferably, the track is made of a thermochromic material having a first degradation temperature, while the track-groove is surrounded by a thermochromic material having a second degradation temperature significantly higher than said first degradation temperature. Thus only the first material will be degraded during writing.

According to another embodiment the thermochromic material has a temperature-dependent absorption characteristic, particularly having an increased absorption at elevated temperatures. The change is preferably non-permanent and ideally reverses immediately when the heating radiation, generated by the laser focused on the addressed layer in which information is to be written, is switched off. The thermochromic effect can be used for writing with any storage mechanism using the absorption of radiation, e.g. writing by photo-induced chemical reactions, since the thermochromic effect introduces a non-linearity in the interaction. In the case of thermo writing, there is already a strong non-linearity, and the additional benefit of the thermochromic effect is the better addressability of the recording layer. In case of chemical and photochromic reactions which are normally linear in intensity, the thermochromic effect can be used to introduce a writing threshold, thus making these techniques better suited for storage applications.

In principle, the same effect can be used for the selective addressing of one layer for read-out as well.

One storage technique that is especially suited to take advantage of the thermochromic effect is one based on fluorescent read-out of the stored information. The general concept is known and e.g. described in WO 98/50914 A1. The incoherent fluorescent light is emitted in response to an incident beam during read-out and carries the recorded information. At the in-focus layer, the higher intensity of the optical beam causes an increase in temperature with regard to the non-addressed layer. Thereby, the absorptivity of the fluorescent molecule at the reading wave length is strongly increased, allowing in principle 100% absorption of the reading beam and thereby an enhanced fluorescence signal.

A significant boundary condition is the cyclicity of the reversible thermochromic effect that has to take place at every read-out. Also, the temperature difference needed to initiate the effect should be relatively low for power consumption as well as material stability reasons. On the other hand, it has to be above the operating temperature of the storage device.

The thermochromic material and the fluorescent material (dyes) are in a first embodiment different entities, i.e. the pure materials are mixed together. Alternatively, the fluorescent function and thermochromic function can be combined in the same moiety. Thus, one or both of these materials can be used in an inert matrix, either by dissolution of said material or materials, dispersion as separate solid or separate liquid phase, adsorption on a different binder or carrier material, complexation etc. The matrix can be of solid or semi-solid nature, preferably of organic nature, such as polymeric nature. But also organic-based gel-type (network-type) matrix materials are for instance possible.

Different materials can be used as thermochromic material according to the present invention. Preferred embodiment thereof are defined in claims 10 to 16. The recording material itself can be a phase-change material or a write-once material that may combine both thermochromic and recording properties.

A method of recording information on an information carrier according to the present invention is claimed in claim 18. Said method exploits the non-linearity of the thermochromic effect to enable a writing method which is normally not practicable for storage since it is linear in intensity and do not show an intrinsic threshold needed for stable writing (the information will be erased by repeated reading or by writing in different layers). It should be noted that this works best, if the initial absorption at the writing wavelength is zero. It is proposed to use two different wavelengths for writing with a non-thermal process that is linear in absorbed intensity. Firstly, the heating wavelength is used in conjunction with the thermochromic effect to increase the absorptivity of the material at second, writing wavelength (from essentially zero). Then at that second wavelength the information is written selectively only in the heated layer.

The heating wavelength is thus the key that enables the true writing channel at the second wavelength.

The invention will now be explained in more detail with reference to the drawings in which

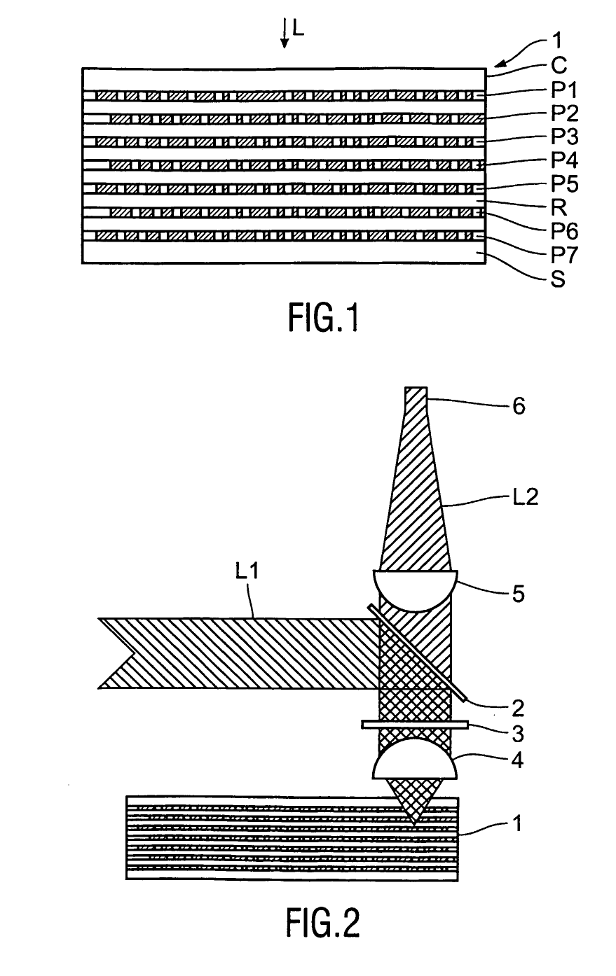

FIG. 1 shows a cross-section of a multi-stack optical information carrier according to the present invention,

FIG. 2 illustrates reading and writing on an information carrier according to the present invention,

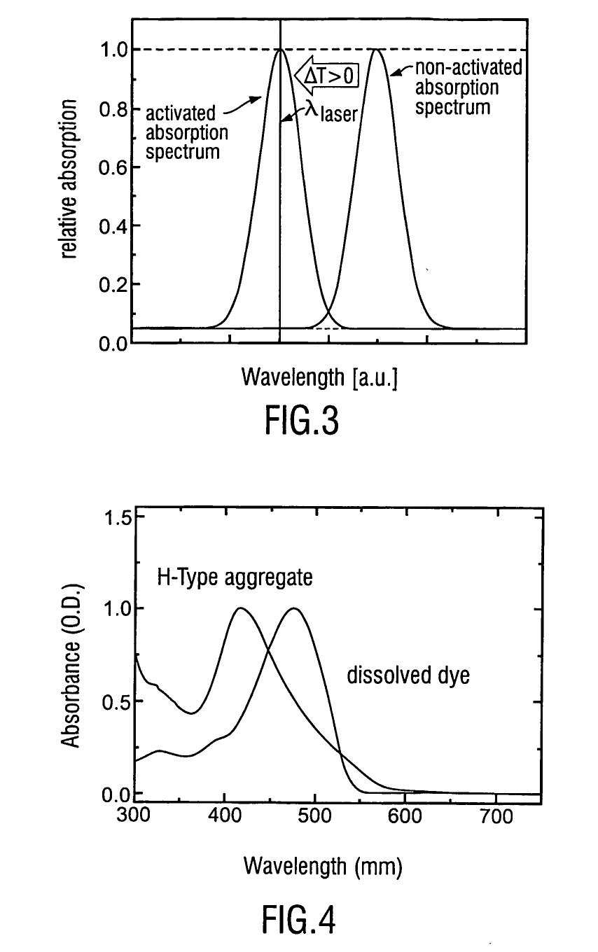

FIG. 3 illustrates the principle of increased absorption,

FIG. 4 illustrates the change in absorption spectrum by formation of aggregation, in particular showing a blue shift,

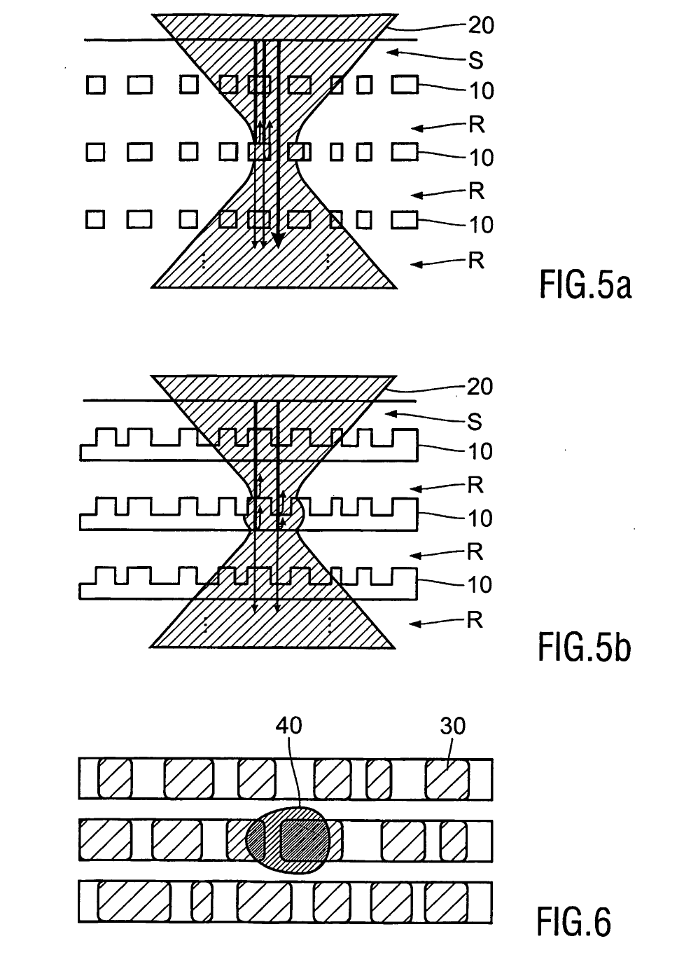

FIG. 5 shows side views of an implementation of a thermochromic ROM carrier where the thermochromic material shows a temperature-dependent reflection characteristic,

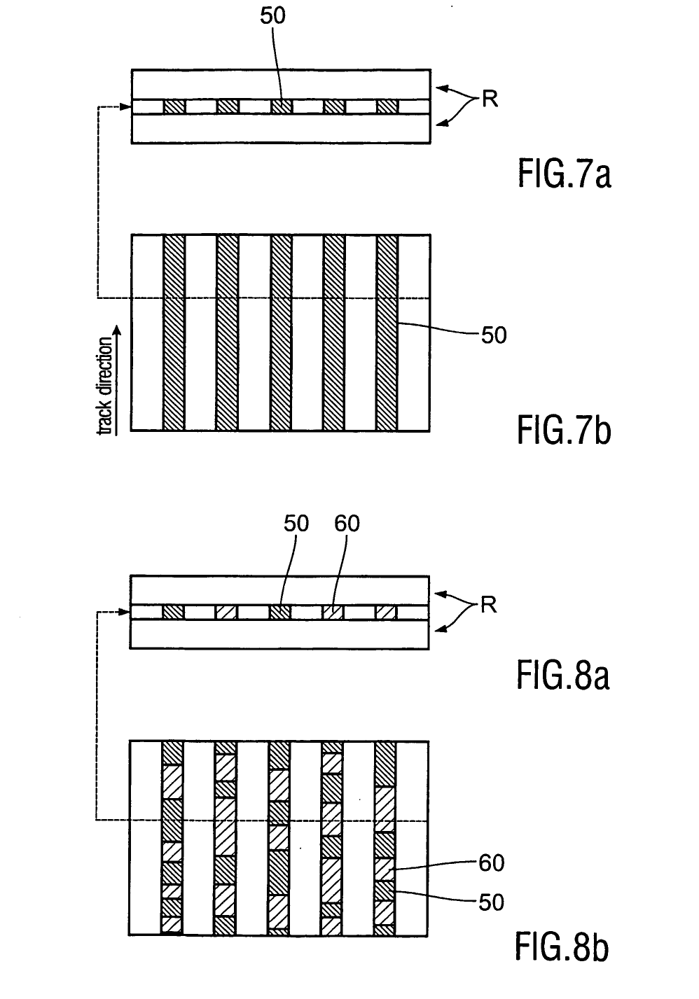

FIG. 6 shows a top view of the carrier shown in FIG. 7,

FIG. 7 shows the concept of a WORM implementation with unwritten tracks,

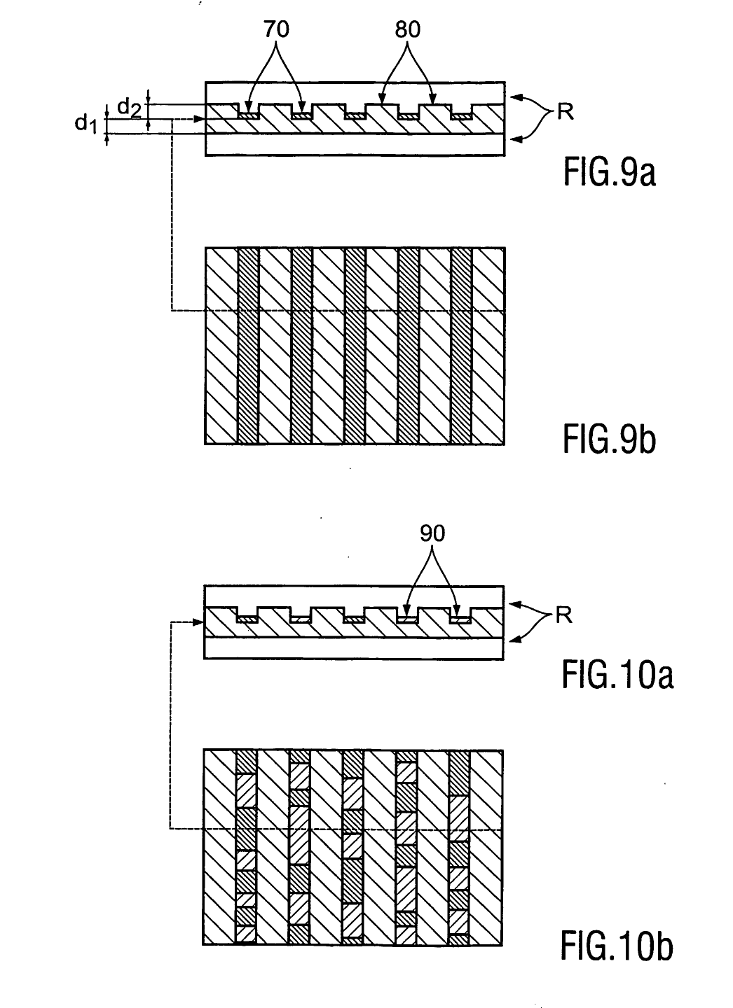

FIG. 8 shows the WORM implementation of FIG. 9 with written tracks,

FIG. 9 shows the concept of another WORM implementation with unwritten tracks,

FIG. 10 shows the WORM implementation of FIG. 11 with written tracks,

FIG. 11 shows a compound having a change in pH, and

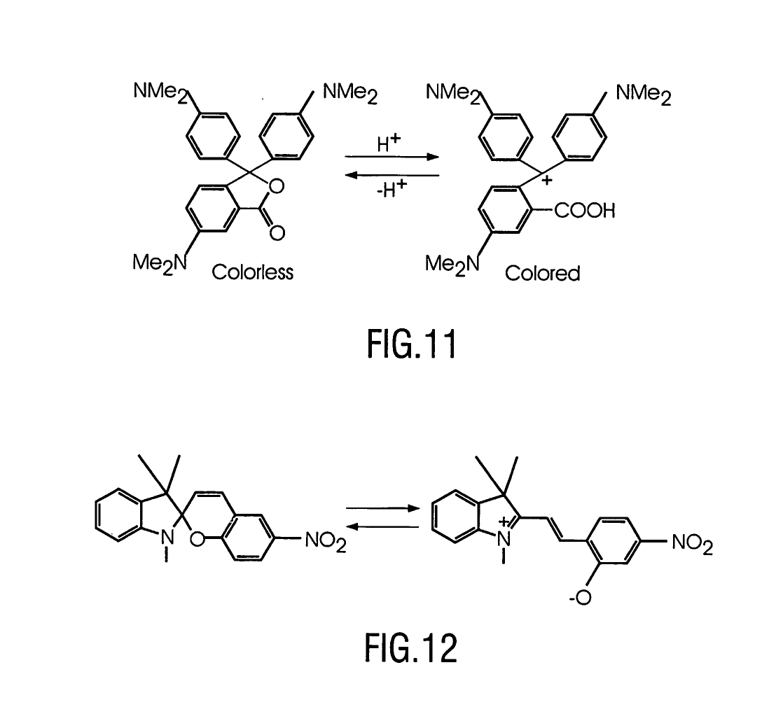

FIG. 12 illustrating the thermochromic effect by ring-opening in spiropyran.

FIG. 1 shows a first embodiment of a multi-stack optical information carrier according to the present invention. On top of the carrier a cover layer C for protection is provided, onto which an optical beam L, such as a laser beam or light generated by LEDs, is incident. Thereafter a number of recording stacks, in the present example 7 recording stacks, each comprising a single recording layer P1 to P7 are provided. The recording stacks, and thus also the recording layers P1 to P7, are separated by spacer layers R to optically and thermally separate adjacent recording layers. Below the deepest recording layer P7 a substrate S, e.g. of polycarbonate, is provided.

The information carrier according to the present invention is thus formed by an alternating stack of inert passive spacer layers R and active recording layers P1-P7. The spacer layers R are optically inactive and transparent and have a thickness of preferably between 1 and 100 μm, in particular between 5 and 0.30 μm. The recording layers P1 to P7 have a thickness of preferably between 0.05 and 5 μm.

Besides the recording and information carrying functionality, a thermochromic functionality is provided in said recording layers P1-P7 to provide a temporary reversible effect of increasing the interaction of the incoming light with the addressed recording layer. Depending on the implementation, the change in the imaginary and/or the real part of the refractive index leads to a change in the absorption, reflection and transmission characteristics which is then used for read-out. These functionalities are preferably combined in one material but can, in the case of a fluorescent storage system, also be separated in different materials.

Since in all but the addressed recording layers the light intensity is low the thermal profile stays either below a threshold temperature such that no change in the absorption profile happens at all, a change meaning a spectral shift or a change in form, or that the change is not large enough to introduce an increase in absorptivity at the desired wavelength, e.g. a spectral shift of the profile towards the laser wavelength which might be linear in temperature but without the higher absorption part of the spectrum reaching it. Therefore, only in the addressed recording layer an increase in temperature is achieved that is significant enough to increase the absorptivity at the desired wavelength.

The composition of the recording layer is dependent on the choice of thermochromic material. Preferred materials showing a desired thermochromic material will be explained in detail below.

The refractive index of recording layers and spacer layers should be matched for the temperatures encountered in the out-of-focus layers to minimize reflections at the interfaces.

In the embodiment using fluorescent read-out, the recording layers P1-P7 further comprise a fluorescent material. Optical record carriers and a method of manufacturing thereof having such fluorescent material in the recording layers are known from WO 98/50914. The recording layer is therein either coated with a fluorescent material, or the surface structures (pits) are filled with a fluorescent material. When the optical beam hits the recording layer, fluorescent light is emitted. The emitted light has a different wavelength from the incident laser light, i.e. is shifted towards the red end of the light spectrum, and is incoherent in nature, in contrast to the reflected light in current optical devices. If the emission spectrum has no overlap with the absorption spectrum, the emitted light is not affected by data or other marks, and traverses adjacent recording layers undisturbed. In the read-out system of the drive the light is color filtered, so that only the information-bearing fluorescent light is detected, thus reducing the effect of stray light. Additional filtering of is done with a semi-confocal set-up to reduce fluorescent light from out-of-focus layers. The invention can be advantageously implemented in such recording layers.

According to the above described embodiment the thermochromic material is different from the fluorescent material, which is particularly a dye, but after excitation by the incident radiation it transfers its excited energy to the fluorescent material during read-out.

According to another preferred embodiment, the material showing the thermochromic effect also has fluorescent properties such that the emitted signal is increased by the increased absorption of radiation during read-out.

The principle of recording and read-out of an optical carrier according the implementation using fluorescent read-out is illustrated in FIG. 2. Excitation light L1 is directed onto the carrier 1 by a beam splitter 2 (preferably a dichroic mirror which is reflective at the excitation wavelength transmitting at the fluorescent wavelengths), passes through the spherical aberration (SA) compensator 3 and is focused onto the recording layer to be addressed by the objective lens 4. The information carrying light L2, which is fluorescent light from the recording layer 1 as described above and shown in FIG. 1, is passing through the objective lens 4, the spherical aberration compensator 3, the beam splitter 2, and is directed onto a light detector 6 by another lens 5. In addition to the dichroic mirror, a color filter can be placed in the detection light path behind the beam splitter 2 to reduce the amount of stray light on falling on the detector 6. The semi-confocal detection is achieved either by appropriately matching the detector size to the size of the spot image, as is shown in FIG. 2, or by using a pinhole of appropriate size in the detection path.

The effect of the present invention is illustrated in FIG. 3. At ambient temperature, the relative absorption at the laser wavelength laser is small. Therefore, all out-of-focus recording layers are almost transparent to the incident light. Only at the addressed recording layer the intensity of the laser is high enough to heat up the material sufficiently to change the optical properties significantly, thereby further increasing the temperature and the localized heating.

In the following another embodiment of the invention shall be explained in more detail where the thermochromic material shows a temperature-dependent reflection characteristic. A reflective multi-layer system is a direct extension of the existing optical storage roadmap and offers the best possible compatibility with existing drive set-ups since only means of spherical aberration compensation have to be added. The thermochromic material has an index of refraction that is matched at ambient temperature exactly to the index of refraction of the substrate material. Therefore no reflection will occur at the substrate-recording layer interface. The material does show some limited absorption at ambient temperature that is enough to initiate the self-amplifying thermochromic effect at the focus. At the focus, due to the self-amplified heating, not only the absorption profile shifts, as shown in FIG. 4, but according to the Kramers-Kronig relation also the real part of the refractive index.

Typical dyes considered now for blue wavelength recording have refractive index of approximately n_{D}=2.2 (depending on the position of the absorption maximum versus the used laser wavelength), thus leading to a peak reflectivity for a standard polycarbonate substrate material (n_{FPC}≈1.5) of approximately R=((n_{D}−n_{FPC})/(n_{D}+n_{FPC}))²=3.6%.

It should be noted that this is of the same order of magnitude as the reflectivity of a dual layer RW BD disc and can be achieved for every layer, independent of the total number of layers. Moreover, standard tracking and timing methods can be used for the present implementation. Using materials with higher difference in their refractive indices (e.g. fluorinated polymers with n≧1.3) would increase the reflectivity.

In an implementation of a ROM system the thermochromic layer is patterned (using conventional and established techniques, such as wet embossing, injection molding, (photo)lithographical techniques, micro-contact printing, vapor deposition) with the pit shape and depth optimized to give in reflection an optimal readout and tracking signal just as in standard ROM systems. Apart from the small reflectivity, any feedback to the drive about the presence of the thermochromic effect is not required and can thus be largely compatible with standard, now available drives except for the need to compensate for the aberrations introduced by the varying focal depths.

It should be mentioned that in the following implementations tracks similar to current disc systems are shown. However, this is not meant to be limiting, other implementations e.g. in card systems with possibly non-scanning data access and/or 2D information coding are just as well possible, such as a non-scanning card with broad beam illumination and detection using CCD sensors. Further, it should be noted that the drawings are not on scale.

FIGS. 4a, b show side views of an implementation of a thermochromic ROM reflective system with combined amplitude and phase grating (FIG. 5a) and pure phase grating (FIG. 5b). The carrier comprises a substrate cover layer S, thermochromic layers 10 with embossed ROM structure and spacer layers R (possibly containing an adhesion layer). The indices of refraction of layers S, 10, R are identical at ambient temperature. The hatched area 20 indicates the optical beam shape. The temperature increases significantly above ambient only in the beam waist.

Different options of implementations are possible for the reflective ROM system. In particular, apart from the implementations shown in FIG. 5, an implementation with a homogenous thickness of the single thermochromic layer is also possible.

FIG. 6 shows a top view of the thermal profile in a thermochromic ROM (scanning) reflective system shown in FIG. 5. The areas 30 posess thermochromic properties, which is activated in the central area 40 which indicates the in-plane temperature profile generated by the scanning spot.

An implementation of the reflective embodiment on a WORM system shall now be explained. In principle, a high-to-low writing effect can be achieved simply by heating the material above a threshold temperature where it loses the thermochromic properties and reverts permanently back to its non-reflective state with the refractive index n matched to that of the surrounding substrate/spacer material. If the transition beyond the mentioned threshold is accomplished by or accompanied by degradation of the thermochromic material, care has to be taken that the material is chosen such that the average refractive index of the generated fragments closely matches that of the surrounding matrix.

A very positive feature of this writing concept, as used in the below described first implementation, is the resulting high value of the modulation (in principle 100%). This is important to achieve high data rates for high density systems where the highest data spatial frequencies lie close to the modulation transfer function cut-off and are thus strongly attenuated by the optical system. A high modulation therefore is directly beneficial for the achievable data rate.

In a first WORM implementation one single thermochromic material is used and deposited in the tracks. The thermochromic material can be used as such, or can be incorporated in a host matrix by dissolution, dispersion, adsorption on a binder, complexation etc. The layer thickness is chosen to provide adequate information and tracking signals. The concept is illustrated in FIGS. 9 and 10. It is to be noted that for illustration the tracks are shown as straight lines. Of course, e.g. timing information can be put into track wobble such as used in standard recording.

FIG. 7a, b shows the a side view (FIG. 7a) and a top view (FIG. 7b) of the first implementation with unwritten tracks; FIG. 8a, b shows the a side view (FIG. 8a) and a top view (FIG. 8b) of the first implementation with written tracks. Thermochromic material 50 is deposited in tracks and locally degraded as indicated by 60. The spacer layers R are index-matched and inactive. After writing, only the non-degraded parts of the track still show the thermochromic effect such that a modulation of the reflected light is achieved.

A second WORM Implementation is illustrated in FIGS. 9 and 10. Therein another concept is applied using two materials with different degradation temperatures that both exhibit a thermochromic effect. FIG. 9a, b shows the a side view (FIG. 9a) and a top view (FIG. 9b) of the first implementation with unwritten tracks; FIG. 10a, b shows the a side view (FIG. 10a) and a top view (FIG. 10b) of the first implementation with written tracks.

The track predominantly consists of a thermochromic material 70 with a degradation temperature in the order of the typical process temperature encountered during the writing process. The track-groove is surrounded by material 80, also exhibiting thermochromic properties, but with a degradation temperature significantly higher than the temperatures encountered during the writing process. Due to this higher degradation temperature and the lower light intensity at the edge of the pre-grooved track (i.e. a lower temperature) compared to the intensity in the center of the laser spot, only material 70 will be degraded during writing as indicated in FIG. 10a by 90.

Again, the thermochromic materials can be used as such, or can be incorporated in a host matrix by dissolution, dispersion, adsorption on a binder, complexation etc. The track-groove can be fabricated using for instance conventional techniques such as embossing or micro-contact printing.

An advantage of this implementation is that continuous servo signals are generated in both the unwritten and written state. The achieved contrast in this implementation depends on the detailed layout and material properties of the recording stack. The “land”-layer made from material 80 has a maximum thickness of d₁+d₂ with the extra extension beneath the storage layer of thickness d₁. FIGS. 9 and 10 show an implementation, but there are other variations possible, e.g. a layer with homogeneous thickness having d₁=0 and d₂=0.

The multilayer structure can also be optimised for read-out in transmission. Here the absorption, reflection and phase differences introduced during the transmission of the optical beam through the activated layer cause a modulation of the signal power on the detector. This implementation is a possible variation of the system which is possible.

There are many materials for which the optical properties change as a function of temperature. The thermochromic behavior can have several different origins. Several classes of materials are described below which can be used to achieve the desired effect.

In elongated (π-)conjugated molecules or polymers the thermochromic effect is caused by the change in conformational freedom with temperature. At low temperatures the conformational freedom is limited and as a result the conjugated molecules have a relative planar geometry. With increasing temperature there is an increase in the conformational freedom and the geometry of the molecules is less planar. Consequently the effective conjugation in the molecules decreases with increasing temperature, resulting in a blue-shift of the absorption band. The shift in the onset of the absorption is only minimal.

Although the effects with temperature are significant, the practical use of elongated conjugated molecules seems limited. Increasing the temperature results in a blue-shift of the absorption band and at present, the thermochromic effects seems to be most pronounced at lower temperatures (below room temperature). Since the thermochromic effect is caused by changes in thermal vibrations it can be very fast (<ps).

Many compounds are known that change their color (absorption spectrum) with a change in pH. Examples of such compounds are fluoran derivatives and crystal violet lactone as illustrated in FIG. 11. A thermochromic mixture can be obtained if these pH-sensitive dyes are mixed with a color-developer and a solvent. For reversible systems the color developers are weak acids while strong acids can be used to obtain irreversible thermochromic systems. The pH sensitive dyes and the color developers are dissolved or mixed in a third compound, generally alcohols or esters. The melting point of the third compound (solvent) determines the temperature at which the color change will occur. As the solvent melts, the dye can react with the (weak) acid, resulting in a color change. Generally, the coloured form can be frozen by rapid cooling, while the colourless dye is formed upon slow cooling.

Some systems show a red-shift upon heating. The exact rate constants for coloration are not known at present, however, significant coloration can be achieved within 1 ms by using a thermal printing head as known from U.S. Pat. No. 5,395,815.

Most derivatives of spiropyrans, spirobichromenes and spirooxazines exhibit photochromic as well as thermochromic behaviour. Upon radiation with the appropriate wavelength light or upon heating these compounds undergo a reversible ring-openings reaction to a zwitter-ionic and highly coloured species as illustrated in FIG. 12.

The rate constants for the photochromic processes are very high. Upon irradiation the ring-opened species is formed within 10 ns (spiropyrans) or within picoseconds (spirobichromenes). The rate constants for the thermochromic processes may be significantly lower, and the decolouration reaction upon irradiation is very fast. Therefore, these compounds are most probably not very suited to obtain the desired thermochromic effect in storage media.

The fatigue resistance of spiropyrans is not very high, however the spirobichromenes and spirooxazines possess a high fatigue resistance.

It is also possible to dissolve sterically hindered photochromic materials in a glassy polymer matrix. The rate constant for the photochromic processes are strongly dependent on the amount of the volume in the polymer matrix, and therefore, they are strongly dependent on the temperature. For sterically hindered photochromic compounds the free volume in a polymer matrix below T_{g} will be insufficient. Above the glass transition temperature of the polymer there will be a significant increase in the rate constants of the photochromic processes as a result of the increased free volume. As a result, both the reaction rate of the coloration as well as the discoloration reaction will increase. The equilibrium shifts towards the non-coloured form with increasing temperatures, however for other photochromic dyes the situation might well be different.

Another possibility is to use reversible aggregation/dissociation. The optical properties of dyes will change significantly upon aggregation of the molecules. Different types of aggregates can be formed: J-type aggregates and H-type aggregates. The formation of J-type aggregates will result in a red-shift of the absorption maximum while the formation of H-type aggregates will result in a blue-shift of the absorption maximum and a red-shift of the onset of absorption as shown in FIG. 4. This way, the aggregation and dissociation of dye molecules will result in a change of the absorption spectrum with temperature.

If the thermochromic effect is used in a storage system based on fluorescent read-out and for heating and excitation of fluorescence the same wavelength is used, the fluorescence quantum efficiency of the material must be chosen such as to achieve just the required heating for the thermochromic effect to be effective, with the remaining part of the absorbed energy being re-emitted as fluorescence light.

According to the present invention the temperature dependence of the absorption and/or reflection spectrum of the record carrier is used to increase the interaction of the incident light with the addressed layer such that writing and/or reading becomes non-linear. Only locally, at the focus of the optical beam, the interaction is increased from its initially low value to the level needed for efficient writing or a large read-out signal. This is achieved by using a thermochromic material.

The present invention therefore has the following advantages: The enhanced optical interaction (e.g. absorption, reflection, modulation of the transmitted beam) can be made very high (in principle up to 100%), much larger than allowable for linear multilayer techniques. In the case of a fluorescent system, in principle, an increase in the read-out signal strength by a factor of 5-25 (for the case of 20 and 100 layer medium, respectively) is therefore possible. The contribution to the background by the non-addressed, out-of-focus layers is greatly reduced, thus increasing the signal modulation. Because of the small out-of-focus contribution, the demands for semi-confocal detection are relaxed. Alternatively, the layers be put closer together while retaining low cross-talk and stable focus tracking, reducing demands on aberration correction for a given number of layers. In case of fluorescent read-out and a red shift of the absorption spectrum, re-absorption of the emitted fluorescent light is strongly suppressed because the effective Stokes-shift with regard to the out-of-focus layers becomes larger. There is less radial cross-talk between neighboring tracks as well as less intersymbol interference (ISI) because only the thermally activated bit in the center of the thermal profile contributes to the read-out signal. Due to the strongly localized thermal profile, in effect the spatial resolution of the system is enhanced above that of linear systems (super-resolution), where it is determined by the broader optical intensity profile. This effect can be used to increase system margins or to increase the lateral density per storage layer.

1. A multi-stack optical information carrier for recording information by means of an optical beam, said optical information carrier comprising
a substrate layer,
at least two recording stacks each comprising a recording layer,
at least one spacer layer separating the at least two recording stacks, and
a cover layer,
characterized in that the recording layers include a thermochromic material having temperature-dependent optical characteristics for selectively improving the sensitivity of the addressed recording layer during recording and/or read-out.

2. A multi-stack optical information carrier as claimed in claim 1, characterized in that said thermochromic material has a temperature-dependent reflection characteristic.

3. A multi-stack optical information carrier as claimed in claim 2, characterized in that the refractive index of the thermochromic material is matched to the refractive index of said substrate and spacer layers.

4. A multi-stack optical information carrier as claimed in claim 2, characterized in that the recording layers include two separate thermochromic materials having different degradation temperatures.

5. A multi-stack optical information carrier as claimed in claim 1, characterized in that said thermochromic material has a temperature-dependent absorption characteristic.

6. A multi-stack optical information carrier as claimed in claim 5, characterized in that the recording layers include a fluorescent material or are coated by a fluorescent material for emitting non-coherent fluorescent light in response to an incident optical beam during read-out, said fluorescent light carrying the information recorded in the addressed recording layer.

7. A multi-stack optical information carrier as claimed in claim 6, characterized in that the thermochromic functionality of said thermochromic material and the fluorescent functionality of said fluorescent material are combined in the same moiety.

8. A multi-stack optical information carrier as claimed in claim 1, characterized in that said thermochromic material and/or said fluorescent material are used in an inert matrix, said matrix being of a solid or semi-solid nature, in particular of an organic nature, polymeric nature or organic-based gel-type nature.

9. A multi-stack optical information carrier as claimed in claim 8, characterized in that said thermochromic material and/or said fluorescent material are used in said inert matrix by dissolution, by dispersion as separate solid or liquid phase, by adsorption on a different binder or carrier material or by complexation.

10. A multi-stack optical information carrier as claimed in claim 1, characterized in that said thermochromic material essentially comprises pure elongated pi-conjugated oligomers or polymers of pi-conjugated materials in a polymer matrix, in particular having a concentration of pi-conjugated material between 1 and 100%.

11. A multi-stack optical information carrier as claimed in claim 1, characterized in that said thermochromic material essentially comprises pH sensitive dye molecules and color developers.

12. A multi-stack optical information carrier as claimed in claim 1, characterized in that said thermochromic material further comprises a polar host material.

13. A multi-stack optical information carrier as claimed in claim 1, characterized in that said thermochromic material essentially comprises a polymer material in which spiropyrans, spirobichromenes or spirooxazines are comprised, in particular dissolved and having a concentration between 1 and 25%.

14. A multi-stack optical information carrier as claimed in claim 1, characterized in that said thermochromic material essentially comprises a polymer material in which sterically hindered photochromic dyes are comprised, in particular dissolved and having a concentration between 1 and 25%.

15. A multi-stack optical information carrier as claimed in claim 1, characterized in that said thermochromic material essentially comprises a polymer material in which thermochromic dyes, in particular cyanine or phthalocyanine dyes, are comprised, in particular dissolved and having a concentration between 1 and 25%.

16. A multi-stack optical information carrier as claimed in claim 1, characterized in that said thermochromic material essentially comprises a dye material in which the dye molecules are aggregated, in particular forming J-type aggregates or H-type aggregates.

17. A multi-stack optical information carrier as claimed in claim 1, characterized in that said recording layers further include as a recording material a phase-change material or a write-once material.

18. A method of recording information on a multi-stack optical information carrier as claimed in claim 1 by use of an optical beam, comprising the steps of directing said optical beam at a first heating wavelength on the recording layer on which information shall be recorded for heating said recording layer and directing said optical beam at a second writing wavelength on the heated recording layer.
